(19) United States
(12) Patent Application Publication
(10) Pub. No.: US 2024/0149429 A1
(43) Pub. Date: May 9, 2024

(54) Mag-Mount

(71) Applicant: Jonathan Adams, Conway, SC (US)

(72) Inventor: Jonathan Adams, Conway, SC (US)

(21) Appl. No.: 18/412,845

(22) Filed: Jan. 15, 2024

(51) Int. Cl. B25H 3/00; F16M 13/02; H01F 7/02

(52) U.S. Cl. CPC B25H 3/00; F16M 13/02; H01F 7/0205

(57) ABSTRACT

A magnetic holder that can be adapted to any flat surface metal or plastic providing magnetic holding of Ferrous objects. Having a waterproof assembly that is washable in cold/hot water. The holder comprises of two neodymium epoxy coated magnets with appropriate size achieving proper hold. Also consisting of proper spacing between the two magnets minimizing movement of objects being held. Further consisting of high bond, double sided foam acrylic adhesive tape to attach magnets to surfaces needing a holder. Currently being used with the Drywall Hawk and Mud Pan.

### FIELD OF THE INVENTION

The present invention is a magnetic holder that can be adapted to any flat surface needing magnetic holding of objects.

### BACKGROUND OF THE INVENTION

Currently some prior art doesn't solve the rotating movement of connecting objects. Also, without the use of materials that are waterproof, it limits the usage of connecting objects being clean with hot/cold water. These problems can be observed specifically during the use of spackle mud pan, drywall hawk, spackle knife.

### SUMMARY OF INVENTION

The present invention seeks to find a solution to problem(s) by providing a quick magnetic holder for ferrous objects. That can be attached to metal and plastic materials. Another object is the use of 2 magnets to be spaced apart from each other to minimize any rotation of the attaching object, this spacing is key to secure objects. Another object is waterproof neodymium epoxy coated magnets with appropriate size achieving proper hold. Another object is the use of high bond, double sided foam acrylic adhesive tape to attach magnets to surfaces.

### BRIEF DESCRIPTION OF DRAWINGS

FIG. 1 Shows 1 neodymium magnet and adhesive assembly

FIG. 2 shows the 2 magnets positioning on an existing drywall hawk

FIG. 3 shows the 2 magnets positioning on an existing mud pan

### DETAIL DESCRIPTION OF DRAWING

Turning now to the drawings in which like reference characters indicate corresponding elements throughout the several views.

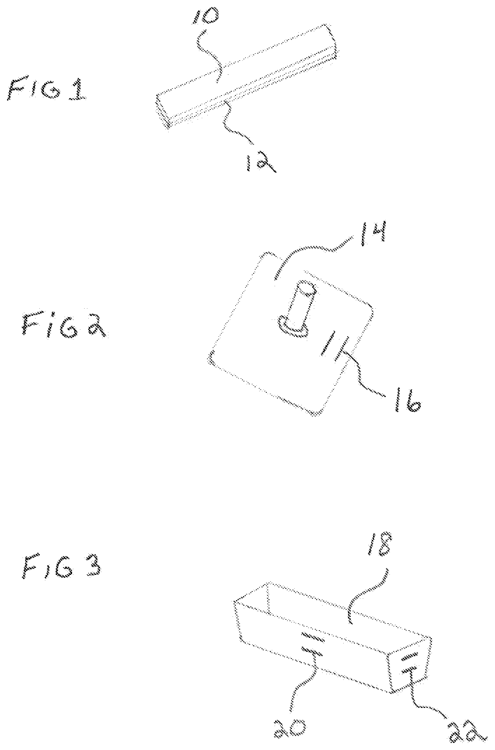

FIG. 1 to be Mag-Mount assembly consisting of 10 neodymium epoxy coated magnets. Body 12 high bond, double sided foam acrylic adhesive tape to attach magnets to surfaces. Leaving the 2nd side of the tape film attached until attached to the tool. To be used in pairs and with proper spacing to minimize the rotation of objects being held and shapes/sized for weight of objects to hold.

FIG. 2 is an example of Mag-Mount assembly being used with an existing drywall hawk 14. 16 is a position example of a magnetic mount assembly.

FIG. 3 is an example of Mag-Mount assembly being used with an existing mud pan 18. 20 is a position example of a magnetic mount assembly. 22 is a position example of a magnetic mount assembly.

1. Mag-Mount is a magnetic tool holder for ferrous objects that can be attached to many materials and objects comprising: Neodymium rare earth magnets, high bond double sided foam acrylic adhesive tape.

2. The mag-mount of claim 1, wherein mag-mount is further comprised of a quantity of two magnets with proper size allowing for maximum grip of said object and low profile

3. The mag-mount of claim 1, wherein mag-mount is further comprised of 1^{st} magnet connected close to tool edge, 2^{nd} magnet to have appropriate spacing minimizes the rotation of the attaching object.

4. The mag-mount of claim 1, wherein mag-mount is further comprised of the magnetic poles are aligned for pairing with each other.

5. The mag-mount of claim 1, wherein mag-mount is further comprised of an epoxy coating making magnets waterproof, can be exposed to water without rusting.

6. The mag-mount of claim 1, wherein mag-mount is further comprised of a position that is outside of the compound storage area.

7. The mag-mount of claim 1, wherein mag-mount is further comprised of high bond, double sided foam acrylic adhesive waterproof tape is attached to both magnets, second side of the adhesive will then be attached to the existing object where a magnetic mount is needed.
